(19) United States
(12) Patent Application Publication
(10) Pub. No.: US 2010/0003956 A1
(43) Pub. Date: Jan. 7, 2010

(54) APPARATUS AND METHOD FOR COMMUNICATION OF MOBILE STATION OF SHADOW AREA IN A MOBILE COMMUNICATION SYSTEM

(75) Inventors: Sang-Min LEE, Seoul (KR); Il-Won KWON, Ansan-si (KR); Chan-Ho MIN, Seoul (KR); Yung-Soo KIM, Seongnam-si (KR)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (KR)

(21) Appl. No.: 12/490,661

(22) Filed: Jun. 24, 2009

(30) Foreign Application Priority Data
Jul. 3, 2008 (KR) 10-2008-0064169

(51) Int. Cl. H04M 11/04

(52) U.S. Cl. 455/404.1

(57) ABSTRACT

An apparatus and method for communication of a Mobile Station (MS) of a shadow area in a mobile communication system are provided. The method includes determining whether an Emergency Ad-hoc Relay (EAR) amble is received and transmitting a help signal when the EAR amble is not received.

### PRIORITY

This application claims the benefit under 35 U.S.C. §119(a) of a Korean patent application filed in the Korean Intellectual Property Office on Jul. 3, 2008 and assigned Serial No. 10-2008-0064169, the entire disclosure of which is hereby incorporated by reference

### BACKGROUND OF THE INVENTION

1. Field of the Invention

The present invention relates to an apparatus and method for providing a communication service. More particularly, the present invention relates to a Mobile Station (MS) located in a shadow area, i.e., in an area out of Base Station (BS) service coverage area.

2. Description of the Related Art

A Mobile Station (MS) located in a shadow area may not be provided with a communication service. However, to avoid user inconvenience, a communication system should be able to recognize a communication request of the MS that is in the shadow area in order to provide the communication service. That is, the communication system should be able to receive a communication request signal transmitted by the MS in the shadow area.

The shadow area MS is not time/frequency-synchronized with a Base Station (BS) and is not synchronized with an in-coverage MS. Thus, there is a need for a transmission/reception method in non-synchronization circumstances.

Also, because an in-coverage MS does not know when or where a communication request signal of a shadow area MS may be received, the in-coverage MS should be able to detect the signal at any time. Because of this requirement, complexity of the MS, power consumption, resource consumption, etc. may be greatly influenced depending on a signal detection method of the in-coverage MS, and a design addressing these concerns is needed.

Similarly, complexity of an MS, power consumption, resource consumption, interference occurrence, etc. may be influenced depending on a scheme of a communication signal request sent by a shadow area MS. More particularly, because it is advantageous that the shadow area MS save power until it enters a service coverage area, power consumption is an issue of great importance. Also, because the communication request signal may act as interference on a different MS, minimizing this interference is needed.

As a scheme for communication between an in-coverage MS and a shadow area MS, there is a “Possible signaling flow” scheme suggested by Janefalkar, etc.

If a shadow area MS continues transmitting an ‘INQUIRE’ message to in-coverage neighboring MSs with various timing, some of the in-coverage MSs may decode a synchronized message among several messages transmitted and, through this, may be aware that the shadow area MS requests a call.

However, in actuality, it is difficult to apply this scheme. First of all, because a shadow area MS continues transmitting an ‘INQUIRE’ message with various timing, the shadow area MS consumes an enormous amount of power until the ‘INQUIRE’ message is successfully sent.

More particularly, considering that power consumption is of more importance to an MS needing an emergency call than any other factor, this scheme is difficult to be applied to an emergency call service.

Also, there is a problem that application to a realistic system is difficult in that, in circumstances where an in-coverage MS mainly focuses on decoding a signal of a BS, simultaneously decoding even an ‘INQUIRE’ message of a neighboring MS imposes a heavy burden on the in-coverage MS in a power or operation capability aspect.

Therefore, a need exists for an improved apparatus and method for communication by a Mobile Station (MS) in a shadow area in a mobile communication system.

### SUMMARY OF THE INVENTION

An aspect of the present invention is to address at least the above-mentioned problems and/or disadvantages and to provide at least the advantages described below. Accordingly, an aspect of the present invention is to provide an apparatus and method for communication by a Mobile Station (MS) in a shadow area in a mobile communication system.

Another aspect of the present invention is to provide an apparatus and method for an MS is a shadow area to request communication with an in-coverage MS in a mobile communication system.

A further aspect of the present invention is to provide an apparatus and method for reducing the amount of time a communication request signal is transmitted by a shadow area MS, for decreasing the inefficiency due to frequency non-synchronization, for reducing additional hardware and software overhead of an MS, for reducing power consumption of an MS and for reducing an amount of interference with an adjacent MS in a mobile communication system.

The above aspects are achieved by providing an apparatus and method for communication of an MS of a shadow area in a mobile communication system.

In accordance with an aspect of the present invention, an operation method of a shadow area Mobile Station (MS) in a mobile communication system is provided. The method comprises determining whether an Emergency Ad-hoc Relay (EAR) amble is received and transmitting a help signal when the EAR amble is not received.

In accordance with another aspect of the present invention, an apparatus of a shadow area Mobile Station (MS) in a mobile communication system is provided. The apparatus comprises a communication modulator/demodulator (modem) for communicating with other nodes and a controller. The controller determines whether an Emergency Ad-hoc Relay (EAR) amble is received through the communication modem and transmits a help signal when the EAR amble is not received through the communication modem.

In accordance with a further aspect of the present invention, an operation method of a Mobile Station (MS) within a service coverage area in a mobile communication system is provided. The method comprises determining whether a help signal is received, determining a response and a response kind when the help signal is received and transmitting, periodically, an Emergency Ad-hoc Relay (EAR) amble.

In accordance with yet another aspect of the present invention, an apparatus of a Mobile Station (MS) within a service coverage area in a mobile communication system is provided. The apparatus comprises a communication modulator/demodulator (modem) for communicating with other nodes and a controller. The controller determines whether a help signal is received through the communication modem, determining a response and a response kind when the help signal is received through the communication modem and transmitting, periodically, an Emergency Ad-hoc Relay (EAR) amble through the communication modem

Other aspects, advantages and salient features of the invention will become apparent to those skilled in the art from the following detailed description, which, taken in conjunction with the annexed drawings, discloses exemplary embodiments of the invention

### BRIEF DESCRIPTION OF THE DRAWINGS

The above and other aspects, features and advantages of certain exemplary embodiments of the present invention will be more apparent from the following description when taken in conjunction with the accompanying drawings, in which:

FIG. 1 is a diagram schematically illustrating a communication service process for a shadow area Mobile Station (MS) according to an exemplary embodiment of the present invention;

FIG. 2 is a flow diagram illustrating an operation process of a shadow area MS according to an exemplary embodiment of the present invention;

FIG. 3 is a flow diagram illustrating an operation process of an in-coverage MS according to an exemplary embodiment of the present invention;

FIG. 4 is a block diagram illustrating a construction of an MS in a wireless communication system according to an exemplary embodiment of the present invention;

FIG. 5 is a diagram illustrating timing of a shadow area MS and an in-coverage MS according to an exemplary embodiment of the present invention;

FIG. 6A is a diagram illustrating a phase of a help signal according to an exemplary embodiment of the present invention; and

FIG. 6B is a diagram illustrating a transmission process of a help signal according to an exemplary embodiment of the present invention.

Throughout the drawings, like reference numerals will be understood to refer to like parts, components and structures

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

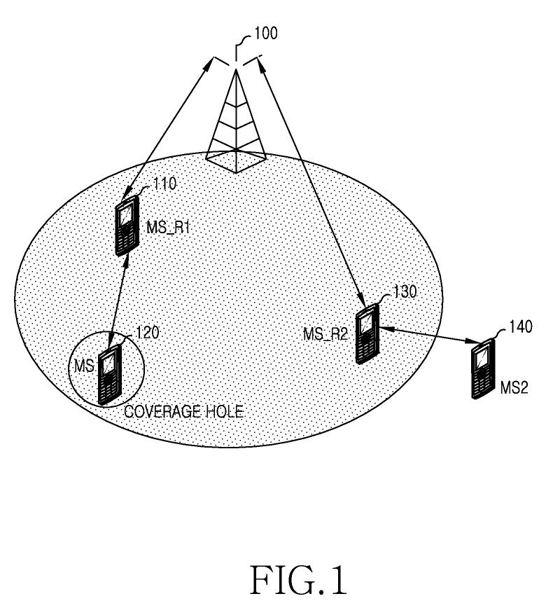

FIG. 1 is a diagram schematically illustrating a communication service process for a shadow area MS according to an exemplary embodiment of the present invention.

Referring to FIG. 1 a communication service is to be provided between MSs 120 and 140, wherein both MSs 120 and 140 are located in a shadow area of Base Station (BS) 100. Also, a communication service is to be provided between MS_R1 110 and MS_R2 130, wherein both MS_R1 110 and MS_R2 130 are within the service coverage area of BS 100. According to an exemplary embodiment of the present invention, a service in which the in-coverage MSs 110 and 130 relay a communication between the shadow area MSs 120 and 140 and the BS 100 respectively is provided.

A summary of an exemplary operation is given as follows.

If a shadow area MS needs a communication service, the shadow area MS attempts Emergency Ad-hoc Relay (EAR) amble detection. If detecting an EAR amble, the shadow area MS synchronizes to the EAR amble and requests access to an EAR. If failing to detect the EAR amble, the shadow area MS transmits a help signal.

If recognizing the help signal, an in-coverage MS reports to a BS and exchanges information (or, a corresponding in-coverage MS determines a response or non-response) and then, the corresponding in-coverage MS becomes an EAR and transmits an EAR amble.

The shadow area MS repeats a process of transmitting a help signal during a ‘T1’ duration and searching a response signal during a ‘T2’ duration. While repeating this process, the shadow area MS may increase a transmit power of the help signal up to a defined level.

If detecting an EAR amble, the shadow area MS discontinues this repeated process, and requests access to the in-coverage MS having transmitted the EAR amble.

The help signal has a continuous phase during the ‘T1’ duration. The help signal may be comprised of a plurality of subcarriers of a defined frequency and, in this case, may reduce interference on an adjacent MS.

Assuming that a period for help signal search in the in-coverage MS is equal to ‘T3’, it is efficient to define ‘T1’ as an integer multiple of ‘T3’. In the case of a multiple Frequency Assignment (FA) system, it is also possible to transmit a help signal with a change of FA.

The in-coverage MS searches a help signal during a ‘T4’ duration within the defined help signal search duration (T3).

The EAR amble is a signal having a constant time length and pattern. A form of a response signal to the EAR amble may be defined to be of a plural number. The BS or in-coverage MS may select and use response signals from among a plurality of response signals.

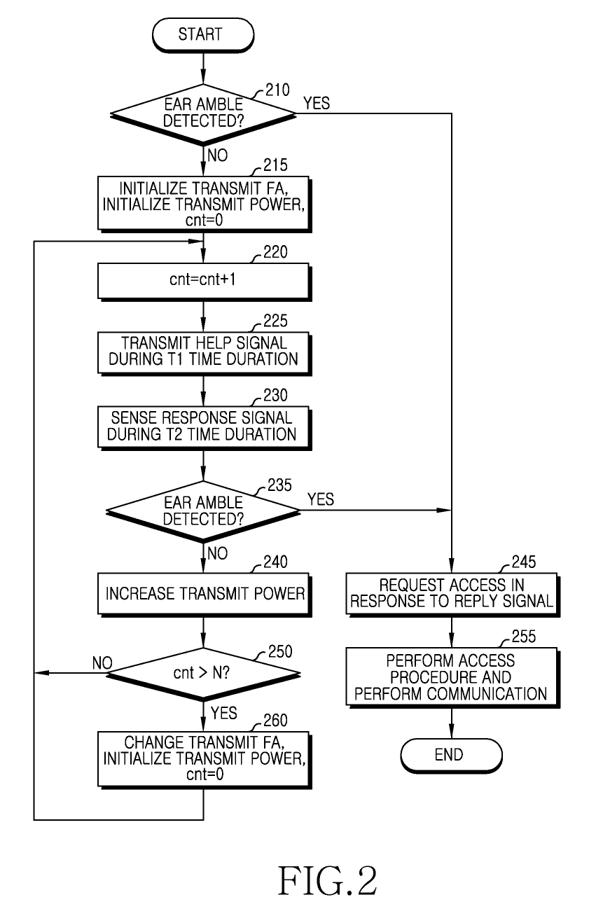

FIG. 2 is a flow diagram illustrating an operation process of a shadow area MS according to an exemplary embodiment of the present invention.

Referring to FIG. 2, if the shadow area MS intends to request communication with an in-coverage MS, the shadow area MS sequentially performs operations as follows.

In step 210, the shadow area MS determines if an EAR amble is detected. If detecting an EAR amble, in step 245, the shadow area MS requests access to an MS having transmitted the EAR amble in response to a reply signal. In step 255, the shadow area MS performs a time and frequency synchronization using the EAR amble and attempts to access the MS having transmitted the EAR amble. After performance of access to the MS having transmitted the EAR amble, the procedure ends.

On the other hand, if the shadow area MS determines that an EAR amble is not detected, in step 215, the shadow area MS initializes a transmit power (P) of a help signal that is a communication request signal, and initializes a counter indicating the current number of times (cnt) of help signal transmission. In step 220, the shadow area MS increases the current number of times (cnt) of help signal transmission by one.

In step 225, the shadow area MS transmits a help signal during a duration (T1). The help signal is sustained during the ‘T1’ duration and has a continuous phase at each of frequencies (f₁, f₂, . . . , f_{N}) of a predefined ‘N’ number, and may be expressed by Equation 1 below.

X(t)=P*(cos(2π f₁t)+cos(2π f₂t)+ . . . +cos(2π f_{N}t)), 0<t<T1 (1)

In Equation 1, the frequencies of ‘N’ number may be selected within an operation frequency band of a communication system of an MS or within a guard band.

In step 230, the shadow area MS attempts EAR amble detection during a duration (T2). The EAR amble is a sequence (ACK(t), 0<t<T_ACK) of a pattern of a T_ACK length (T_ACK<T2) on a time axis.

During the ‘T2’ duration, the shadow area MS may detect an EAR amble by continuously sensing a receive signal and detecting the existence or absence of the sequence (ACK(t)) of the pattern.

In step 235, the shadow MS determines if an EAR amble is detected. If the EAR amble is not detected, in step 240 the shadow area MS increases a transmit power for a subsequent transmission process. For example, the shadow MS may increase as given in ‘P=P+d’.

In step 250, the shadow area MS determines if the current number of times (cnt) of help signal transmission exceeds the maximum number (N) of times of transmission. That is, the shadow area MS determines if the variable value exceeds the maximum number (N) of times of transmission.

If the variable value exceeds the maximum number (N) of times of transmission, in step 260, the shadow area MS changes a transmit FA of a help signal and initializes the variable value (cnt) to 0. Then, the shadow area MS returns to step 220, increases the current number of times (cnt) of help signal transmission by one and proceeds with the subsequent steps.

On the other hand, if the variable value does not exceed the maximum number (N) of times of transmission, the shadow area MS returns to step 220, increases the current number of times (cnt) of help signal transmission by one and proceeds with the subsequent steps.

Accordingly, until there is an excess of the maximum number (N) of times of transmission, the shadow area MS continues transmitting a help signal using a current frequency resource and, if there is an excess of the maximum number (N) of times of transmission, changes the current frequency resource and transmits a help signal.

Then, the shadow area MS terminates the process according to an exemplary embodiment of the present invention.

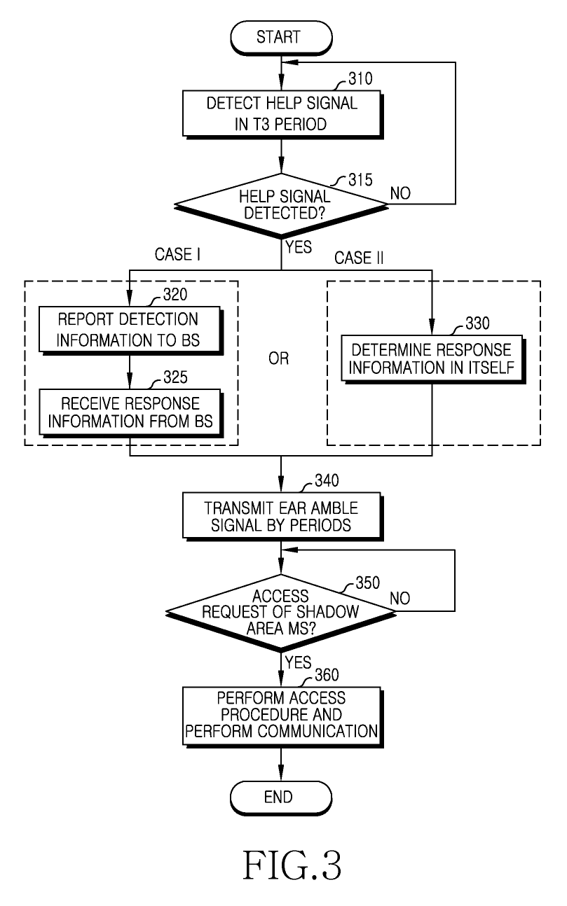

FIG. 3 is a flow diagram illustrating an operation process of an in-coverage MS according to an exemplary embodiment of the present invention.

Referring to FIG. 3, in step 310, the in-coverage MS searches for help signal reception during a defined duration (T4) within a defined search duration (T3). The help signal search may determine reception or non-reception of a help signal by measuring a magnitude of a receive signal at a frequency corresponding to a help signal.

For example, assuming that f₁, f₂, . . . , f_{N} are frequencies of a help signal, the in-coverage MS may determine reception or non-reception of the help signal by measuring a ratio (R) of receive power (PT) of the entire band to receive powers (P(f₁), P(f₂), . . . , P(f_{N})) at frequencies f₁, f₂, . . . , f_{N} and comparing this value with a threshold value. The value of ‘R’ is given as in Equation 2 below.

R=(P(f₁)+P(f₂)+ . . . +P(f_{N}))/PT (2)

An exemplary method for solving this equation upon frequency non-synchronization is given as follows.

If a shadow area MS is not frequency-synchronized with a BS, a frequency deviation is generated as much as an oscillator error of a corresponding MS. Thus, when a frequency for a help signal is defined as f₁, f₂, . . . , f_{N}, the shadow area MS sets a corresponding frequency on the basis of its own oscillator for transmission and transmits a signal at frequencies (f₁+d, f₂+d, . . . , f_{N}+d) including a frequency deviation (d).

Accordingly, the in-coverage MS performs the following operation to compensate for the frequency deviation (d).

The in-coverage MS may determine reception or non-reception of a help signal by determining a power ratio (R(d)) depending on the frequency deviation (d) within a range (−D<d<D) of the frequency deviation (d) and comparing the R(d) value with a threshold value.

The R(d) value may be determined using Equation 3 below.

R(d)=(P(f₁+d)+P(f₂+d)+ . . . P(f_{N}+d))/PT, −D<d<D (3)

In step 315, the in-coverage MS determines if a help signal is detected. If a help signal is detected, the in-coverage MS may perform a process of Case 1 or Case 2 as follows. Here, a condition of selecting one of Case 1 and Case 2 may be based on policy.

In step 320, the in-coverage MS reports detection information and information of the in-coverage MS to a BS.

In step 325, the BS determines help signal response and kind, or non-response, and informs the in-coverage MS.

In step 340, the in-coverage MS periodically transmits an EAR amble in response to the response received from the BS.

In step 350, the in-coverage MS determines if an access request is received from a shadow area MS. If the in-coverage MS determines it has received an access request from an MS of a shadow area, the BS performs an access procedure and communication in step 360.

Referring again to step 315, if detecting the help signal, the in-coverage MS may perform a process of Case 2 as follows.

In step 330, the in-coverage MS determines response and kind or non-response in itself and periodically transmits an EAR amble.

According to this, in step 340, the in-coverage MS periodically transmits an EAR amble.

If it is determined that an access request is received from an MS of a shadow area in step 350, the in-coverage MS performs an access procedure and communication in step 360.

After that, the in-coverage MS terminates the process according to an exemplary embodiment of the present invention.

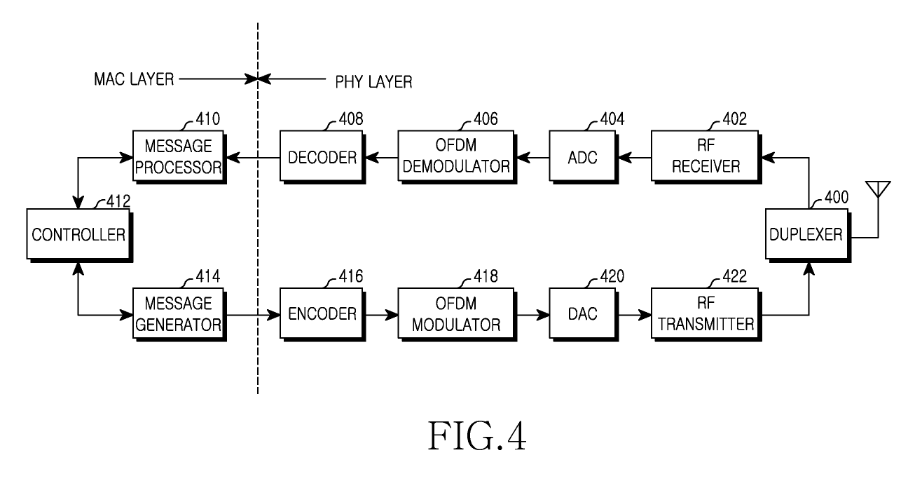

FIG. 4 is a block diagram illustrating a construction of an MS in a wireless communication system according to an exemplary embodiment of the present invention. FIG. 4 illustrates a case in which the MS uses an Orthogonal Frequency Division Multiplexing (OFDM) system. Of course, the present invention is applicable irrespective of a physical factor. In FIG. 4, a factor of a physical layer may be a hardware MOdulator/DEModulator (MODEM).

Referring to FIG. 4, the MS includes a duplexer 400, a Radio Frequency (RF) receiver 402, an Analog to Digital Converter (ADC) 404, an OFDM demodulator 406, a decoder 408, a message processor 410, a controller 412, a message generator 414, an encoder 416, an OFDM modulator 418, a Digital to Analog Converter (DAC) 420, and an RF transmitter 422.

The duplexer 400 forwards a receive signal from an antenna to the RF receiver 402 by a duplexing scheme, and transmits a transmit signal from the RF transmitter 422 through the antenna.

The RF receiver 402 converts an RF signal from the duplexer 400 into a baseband analog signal. The ADC 404 converts an analog signal from the RF receiver 402 into sample data for output. The OFDM demodulator 406 processes, by Fast Fourier Transform (FFT), sample data output from the ADC 404 and outputs data of a frequency domain.

The decoder 408 selects data (i.e., burst data) of subcarriers intended for reception from the frequency domain data from the OFDM demodulator 406, and demodulates and decodes the selected data according to a modulation level (i.e., a Modulation and Coding Scheme (MCS) level) for output.

The message processor 410 detects a packet (e.g., a Media Access Control Packet Data Unit (MAC PDU) in the data from the decoder 408, and performs a header and error check on the detected packet. At this time, if it is determined to be a control message or control signal through the header check, the message processor 410 analyzes a control message or a control signal according to a defined standard, and provides the result to the controller 412. That is, the message processor 410 extracts each variety of kinds of control information from a received control message or control signal and forwards the extracted information to the controller 412.

The controller 412 performs a corresponding process on the basis of information from the message processor 410. Also, if transmission of a control message or a control signal is needed, the controller 412 generates and provides corresponding information to the message generator 414. The message generator 414 generates a message or signal with each variety of kinds of information received from the controller 412 and outputs the generated message or signal to the encoder 416 of a physical layer.

The encoder 416 encodes and modulates data from the message generator 414 according to a modulation level (i.e., an MCS level) for output. The OFDM modulator 418 processes, by Inverse Fast Fourier Transform (IFFT), the data from the encoder 416, and outputs sample data (i.e., an OFDM symbol). The DAC 420 converts the sample data into an analog signal for output. The RF processor 422 converts an analog signal from the DAC 420 into an RF signal and transmits the converted RF signal through the antenna.

In the aforementioned construction, the controller 412 controls processes of the message processor 410 and the message generator 414 which are separately provided. However, the controller 412 may perform the functions of either of the message processor 410 and the message generator 414.

More specifically, the individual elements are separately constructed and illustrated in order to distinguish and describe respective functions according to an exemplary embodiment of the present invention. However, in an actual realization, construction may be such that all of them or only part of them are processed in the controller 412.

A case of an in-coverage MS is described with reference to FIG. 4. The message processor 410 analyzes the received help signal, extracts information on the help signal, and provides the extracted information to the controller 412.

If receiving information on the detected help signal, the controller 412 performs the aforementioned process of Case 1 or Case 2 of FIG. 3. That is, the controller 412 performs an operation of reporting detection information to a BS or receiving a response, or determines performance of a process (i.e., EAR amble transmission) for determining response information in itself for transmission. And, the controller 412 provides information for this operation to the message generator 414.

The message generator 414 receives the information from the controller 412 and, using this, generates a control message (or a control signal) or an EAR amble. The control message (or the control signal) or the EAR amble is transmitted through the antenna after physical layer encoding.

The controller 412 may determine an access request of a shadow area MS, and may transmit/receive information for this through a physical layer.

A case of an MS of a shadow area is now described. The message processor 410 analyzes the received EAR amble, extracts information on the EAR amble, and provides the extracted information to the controller 412.

If failing to receive information on the detected EAR amble, the controller 412 performs the aforementioned process of FIG. 2. That is, the controller 412 performs a process for help signal transmission, and provides information for this operation to the message controller 414.

If receiving the information on the detected EAR amble, the controller 412 determines an access to an MS having transmitted the EAR amble and provides information for this to the message generator 414.

The message generator 414 receives the information from the controller 412 and, using this, generates a control message (or a control signal) or a help signal. Then, the control message (or control signal) or help signal is transmitted through the antenna after physical layer encoding.

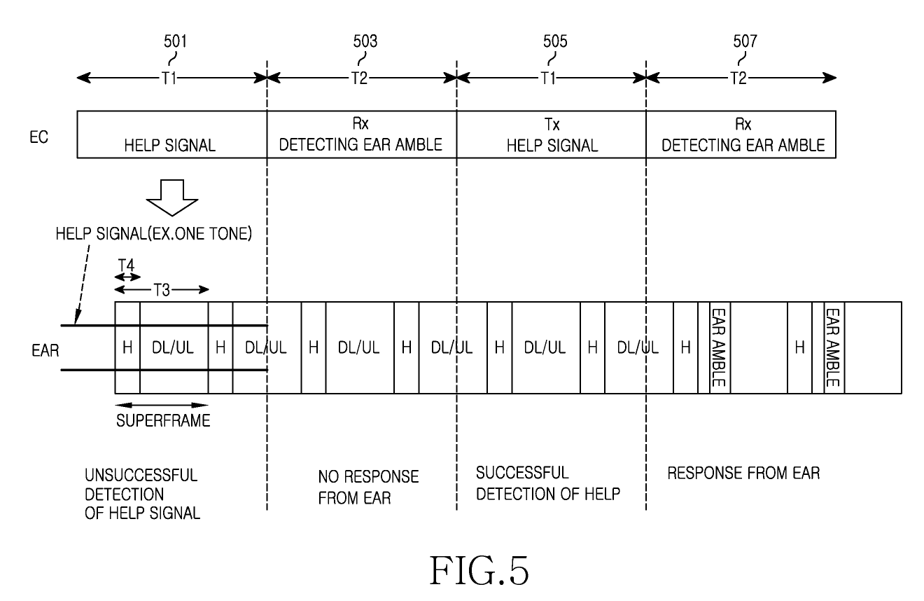

FIG. 5 is a diagram illustrating timing of a shadow area MS and an in-coverage MS according to an exemplary embodiment of the present invention.

Referring to FIG. 5, an Emergency Caller (EC) illustrates a shadow area MS, and an EAR illustrates an in-coverage MS.

FIG. 5 illustrates a process in which the EC transmits a help signal but fails to receive a response from the EAR and, if the EAR detects the help signal, the EC receives an EAR amble from the EAR.

More specifically, during the duration T1 501, the EC transmits a help signal for reception by the EAR. In an exemplary embodiment, the EC may transmit the help signal as described earlier with reference to FIG.2. After transmission of the help signal, the EC determines if an EAR amble is received from the EAR. That is, as described earlier with reference to FIG. 3, if the EAR detects the help signal, it will transmit an EAR amble. However, in duration T2 503, the EAR fails to detect the help signal. Accordingly, the EC again transmits a help signal in duration T1 505. In this instance, the EAR successfully detects the help signal and, in duration T2 507, transmits an EAR amble.

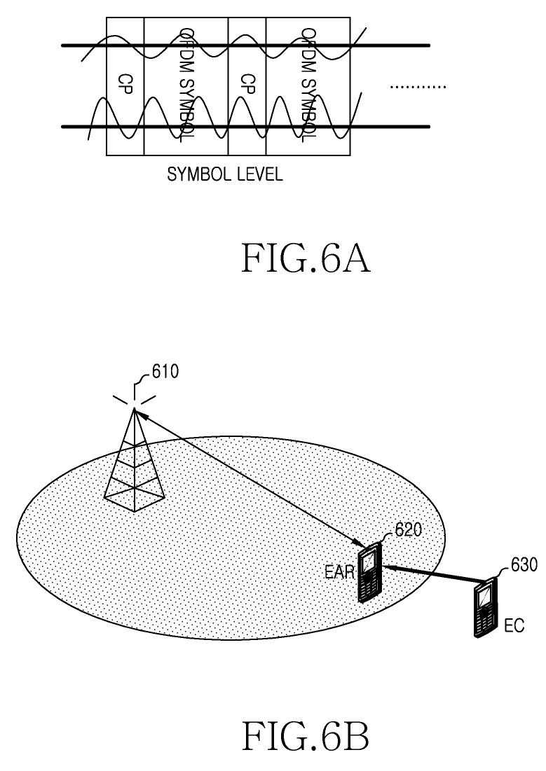

FIG. 6A is a diagram illustrating a phase of a help signal according to an exemplary embodiment of the present invention. FIG. 6B is a diagram illustrating a process of transmitting a help signal according to an exemplary embodiment of the present invention.

Referring to FIG. 6B, if an EC 630 transmits a help signal and an EAR 620 receives the help signal, the EAR 620 informs a BS 610 of help signal reception.

As being identifiable from a symbol level of FIG. 6A, the help signal has a continuous phase during a ‘T1’ duration.

Exemplary embodiments of the present invention have an advantage of reducing an amount of time a communication signal request is transmitted from a shadow area MS, an inefficiency caused by frequency non-synchronization, additional hardware and software overhead for an MS, power consumption of an MS and an amount of interference with an adjacent MS.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An operation method of a shadow area Mobile Station (MS) in a mobile communication system, the method comprising:
determining whether an Emergency Ad-hoc Relay (EAR) amble is received; and
transmitting a help signal when the EAR amble is not received.

2. The method of claim 1, further comprising:
requesting access to an MS having transmitted the EAR amble when the EAR amble is received; and
performing communication via the MS having transmitted the EAR amble.

3. The method of claim 1, wherein the help signal comprises a signal sustained during a help signal transmission duration T1 with a continuous phase at each of frequencies (f₁, f₂, . . . , f_{N}) of a number N, and is expressed as:
X(t)=P*(cos(2π f₁t)+cos(2π f₂t)+ . . . +cos(2π f_{N}t)), 0<t<T1
where the frequencies of N number may be selected within one of an operation frequency band of a communication system of an MS and a guard band.

4. The method of claim 1, wherein the EAR amble comprises a sequence (ACK(t), 0<t<T_ACK) of a pattern of a T_ACK length (T_ACK<T2, wherein T2 comprises the EAR amble reception wait duration) on a time axis.

5. The method of claim 1, wherein the transmitting of the help signal when the EAR amble is not received comprises:
initializing transmission Frequency Assignment (FA) and a transmit power;
repeating transmission of the help signal during a transmission duration and an EAR amble reception wait during a reception duration, up to a maximum number of times of transmission;
performing transmission FA change and re-initialization of transmit power when the EAR amble is not received, up to the maximum number of times of transmission; and
repeating transmission of the help signal during the transmission duration and the EAR amble reception wait during the reception duration and performing transmission FA change and the transmit power re-initialization when the EAR amble is not received, up to the maximum number of times of transmission, after the transmission FA change and the transmit power initialization.

6. The method of claim 5, further comprising:
increasing the transmit power by a magnitude, after repeating transmission of the help signal during a transmission duration and an EAR amble reception wait during the reception duration, up to the maximum number of times of transmission.

7. An apparatus of a shadow area Mobile Station (MS) in a mobile communication system, the apparatus comprising:
a communication modulator/demodulator (modem) for communicating with other nodes; and
a controller for determining whether an Emergency Ad-hoc Relay (EAR) amble is received through the communication modem and for transmitting a help signal when the EAR amble is not received through the communication modem.

8. The apparatus of claim 7, wherein, the controller requests access to an MS having transmitted the EAR amble when the EAR amble is received through the communication modem and performs communication via the MS having transmitted the EAR amble through the communication modem.

9. The apparatus of claim 7, wherein the help signal comprises a signal sustained during a help signal transmission duration T1 with a continuous phase at each of frequencies (f₁, f₂, . . . , f_{N}) of a number N, and is expressed as:
X(t)=P*(cos(2π f₁t)+cos(2π f₂t)+ . . . +cos(2π f_{N}t)), 0<t<T1
where the frequencies of ‘N’ number may be selected within one of an operation frequency band of a communication system of an MS and a guard band.

10. The apparatus of claim 7, wherein the EAR amble comprises a sequence (ACK(t), 0<t<T_ACK) of a pattern of a T_ACK length (T_ACK<T2, wherein T2 comprises the EAR amble reception wait duration) on a time axis.

11. The apparatus of claim 7, wherein the controller:
initializes a transmission Frequency Assignment (FA) and a transmit power;
repeats transmission of the help signal during a transmission duration and an EAR amble reception wait during a reception duration, up to a maximum number of times of transmission;
performs transmission FA change and re-initializes the transmit power when the EAR amble is not received, up to the maximum number of times of transmission; and
performs a process of repeating transmission of the help signal during the transmission duration and the EAR amble reception wait during the reception duration and performing transmission FA change and the transmit power re-initialization when the EAR amble is not received, up to the maximum number of times of transmission, after the transmission FA change and the transmit power initialization.

12. The apparatus of claim 11, wherein, the controller:
increases the transmit power by a magnitude, after repeating transmission of the help signal during a transmission duration and an EAR amble reception wait during the reception duration, up to the maximum number of times of transmission

13. An operation method of a Mobile Station (MS) within a service coverage area
in a mobile communication system, the method comprising:
determining whether a help signal is received;
determining a response and a response kind if the help signal is received; and
periodically transmitting an Emergency Ad-hoc Relay (EAR) amble.

14. The method of claim 13, further comprising:
reporting the help signal reception to a Base Station (BS) if the help signal is received; and
receiving a response to the help signal reception report from the BS.

15. The method of claim 14, wherein the periodically transmitting of the EAR amble comprises:
performing an access procedure with an MS having transmitted the help signal when an access request is received from the MS having transmitted the help signal; and
providing a communication service to the MS having transmitted the help signal.

16. The method of claim 13, wherein the help signal comprises a signal sustained during a help signal transmission duration T1 with a continuous phase at each of frequencies (f₁, f₂, . . . , f_{N}) of a number N, and is expressed as:
X(t)=P*(cos(2π f₁t)+cos(2π f₂t)+ . . . +cos(2π f_{N}t)), 0<t<T1
where the frequencies of ‘N’ number may be selected within one of an operation frequency band of a communication system of an MS and a guard band.

17. The method of claim 13, wherein the EAR amble comprises a sequence (ACK(t), 0<t<T_ACK) of a pattern of a T_ACK length (T_ACK<T2, wherein T2 comprises the EAR amble reception wait duration) on a time axis.

18. The method of claim 13, wherein the determining of whether the help signal is received comprises:
determining whether the help signal is received by measuring a magnitude of a received signal at a frequency corresponding to the help signal, wherein, when frequencies f₁, f₂, . . . , f_{N} are equal to frequencies of the help signal, the reception of the help signal is determined by measuring a ratio (R) of receive power (PT) at the entire band and receive powers (P(f₁), P(f₂), . . . , P(f_{N}) at the frequencies f₁, f₂, . . . , f_{N},
where ‘R’ is given as:
R=(P(f₁)+P(f₂)+ . . . +P(f_{N}))/PT

19. An apparatus of a Mobile Station (MS) within a service coverage area in a mobile communication system, the apparatus comprising:
a communication modulator/demodulator (modem) for communicating with other nodes; and
a controller for determining whether a help signal is received through the communication modem, for determining a response and a response kind when the help signal is received through the communication modem and for periodically transmitting an Emergency Ad-hoc Relay (EAR) amble through the communication modem.

20. The apparatus of claim 19, wherein the controller:
reports the help signal reception to a Base Station (BS) when the help signal is received through the communication modem;
receives a response to the help signal reception report from the BS through the communication modem; and
periodically transmits an EAR amble through the communication modem.

21. The apparatus of claim 20, wherein the controller, in the course of periodically transmitting the EAR amble:
performs an access procedure with an MS having transmitted the help signal when an access request is received from the MS having transmitted the help signal; and
provides a communication service to the MS having transmitted the help signal.

22. The apparatus of claim 19, wherein the help signal comprises a signal sustained during a help signal transmission duration T1 with a continuous phase at each of frequencies (f₁, f₂, . . . , f_{N}) of a number N, and is expressed as:
X(t)=P*(cos(2π f₁t)+cos(2π f₂t)+ . . . +cos(2π f_{N}t)), 0<t<T1
where the frequencies of ‘N’ number may be selected within one of an operation frequency band of a communication system of an MS and a guard band.

23. The apparatus of claim 19, wherein the EAR amble comprises a sequence (ACK(t), 0<t<T_ACK) of a pattern of a T_ACK length (T_ACK<T2, wherein T2 comprises the EAR amble reception wait duration) on a time axis.

24. The apparatus of claim 19, wherein the controller:
determines whether the help signal is received by measuring a magnitude of a received signal at a frequency corresponding to the help signal,
wherein, when frequencies f₁, f₂, . . . , f_{N} are equal to frequencies of the help signal, the reception of the help signal is determined by measuring a ratio (R) of receive power (PT) at the entire band and receive powers (P(f₁), P(f₂), . . . , P(f_{N}) at the frequencies f₁, f₂, . . . , f_{N},
where ‘R’ is given as:
R=(P(f₁)+P(f₂)+ . . . +P(f_{N}))/PT
